(19) United States
(12) Patent Application Publication
(10) Pub. No.: US 2012/0010340 A1
(43) Pub. Date: Jan. 12, 2012

(54) POLYPROPYLENE RESIN COMPOSITION WITH BLACK HIGH GLOSS FINISH

(75) Inventors: Choon Soo Lee, Ansan (KR); Min Hee Lee, Hwaseong (KR)

(73) Assignee: HYUNDAI MOTOR COMPANY, Seoul (KR)

(21) Appl. No.: 12/913,336

(22) Filed: Oct. 27, 2010

(30) Foreign Application Priority Data
Jul. 8, 2010 (KR) 10-2010-0065903

(51) Int. Cl. C08K 3/22; C08K 3/32; C08K 5/54; C08K 5/09

(52) U.S. Cl. 524/262; 524/394; 524/417; 524/430; 524/432; 524/528

(57) ABSTRACT

The present invention provides a polypropylene resin composition prepared by adding a black coloring agent and metal oxide nanoparticles to polypropylene or a mixture of polypropylene and rubber to have a black high gloss finish. The polypropylene resin composition prepared according to the present invention can be used as a substitute for expensive engineering plastics, which have been used for vehicle interior and exterior components with a black high gloss finish, and thus can contribute to a reduction in manufacturing cost and weight and environmentally friendly characteristics.

### CROSS-REFERENCE TO RELATED APPLICATION

This application claims under 35 U.S.C. §119(a) the benefit of Korean Patent Application No. 10-2010-0065903 filed Jul. 8, 2010, the entire contents of which are incorporated herein by reference.

### BACKGROUND

(a) Technical Field

The present disclosure relates generally to a polypropylene resin composition with a black high gloss finish. More particularly, it relates to a polypropylene resin composition with a black high gloss finish for interior and exterior parts components of a vehicle. The present disclosure further relates to methods for preparing polypropylene resin compositions with a black high gloss finish, particularly methods wherein a black coloring agent and metal oxide nanoparticles are added to polypropylene or a mixture of polypropylene and rubber. The present disclosure further relates to interior and exterior parts components of a vehicle comprising the polypropylene resin compositions.

(b) Background Art

Many vehicle interior components, such as center fascias, crash pad garnishes, door trim garnishes, door inner handles, switch bezels at steering wheels, cup holder rings, etc., and exterior components, such as pillar garnishes, trunk lid garnishes, etc., are required to have a black high gloss finish as a design factor according to the vehicle model.

The black high gloss finish has been provided generally by three methods: an insert injection method using black high gloss film, black high gloss paint treatment, and by directly injecting a black plastic raw material as a type of molded-in-color. Among these methods, direct injection of black plastic raw materials has been the most inexpensive method.

In order to provide a high gloss finish by direct injection of plastic raw materials, it is necessary to minimize the roughness of the injection molding die surface such that it is extremely smooth like a glass surface. Moreover, the injection conditions should be optimized so that the smooth surface can be efficiently transferred to the surface of molded products. When injection temperatures are high and a resin having a low fluidity is used, it is necessary to employ a special mold and control system that provides rapid heating and cooling cycles to improve the surface quality properties, such as weld line.

To date, expensive engineering plastics having a high specific gravity have been used to provide a high gloss finish when using direct injection of black plastic raw material methods. Such engineering plastics have included polycarbonates (PC), blends of PC with acrylonitrile butadiene styrene copolymer (PC/ABS), blends of PC with polybutylene terephthalate (PC/PBT), poly(methyl methacrylate) (PMMA), etc. However, such materials have drawbacks. For example, PC and PC blend materials have relatively low chemical resistance and weather resistance. As a result, when using PC and PC blend materials, an additional transparent coating process is required, which increases manufacturing costs. Further, during such transparent coating processes, various volatile organic compounds (VOCs), such as toluene, which are harmful to the environment, are used. Use of PMMA an engineering plastic also has drawbacks. PMMA has a relatively low impact resistance and thus may be damaged by impact, particularly when it is used as an exterior vehicle component.

Therefore, there is a need for improved methods and compositions which provide a black high gloss finish, and which are suitable for use in forming interior and exterior vehicle components.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides a polypropylene resin composition with a black high gloss finish.

In one aspect, the polypropylene resin composition of the invention is prepared by adding a black coloring agent and metal oxide nanoparticles to polypropylene. In some embodiments, a black coloring agent and metal oxide nanoparticles are added to a mixture of polypropylene and rubber. The polypropylene resin compositions prepared by the present methods provide reduced manufacturing costs, have excellent properties including excellent chemical resistance and weather resistance, and are provided with a black high gloss finish, and thus are applicable as interior and exterior components of a vehicle. Further, because the present invention is capable of providing a polypropylene resin composition having a high gloss finish, the present methods do not require a separate coating process, and, as such, is more economical and avoids the associated use of VOCs.

In a preferred embodiment, the present invention provides a polypropylene resin composition comprising: about 90 to 99.8 wt % of polypropylene or a mixture of polypropylene and rubber having a transparency of about 10 to 90%; about 0.2 to 10 wt % of metal oxide nanoparticles; and about 100 to 5,000 ppm of a black coloring agent.

Other aspects and preferred embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle has two or more kinds of power sources, for example, a gasoline and electricity.

The above features and advantages of the present invention will be apparent from or are set forth in more detail in the following Detailed Description, which serves to explain by way of example the principles of the present invention.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The present invention provides a polypropylene resin composition, which does not require a separate coating process due to its high gloss finish, has excellent properties, and is economical. In particular, the present invention provides a polypropylene resin composition that is prepared by adding a black coloring agent and metal oxide nanoparticles to polypropylene or a mixture of polypropylene and rubber. When polypropylene is combined with a black coloring agent in accordance with the present invention, a composition having a black high gloss finish is provided. Metal nanoparticles, which are transparent when dispersed in a polymer resin such as polypropylene, improve scratch resistance and weather resistance.

Polypropylene is a material known to have excellent transparency. Preferably, the polypropylene or the mixture of polypropylene and rubber is transparent. For example, when the amount of visible rays transmitted is large as the crystalline spherulite size of the mixture of polypropylene and rubber is sufficiently small, the polypropylene or the mixture of polypropylene and rubber becomes transparent. In certain preferred embodiments, the transparency of the polypropylene or mixture of polypropylene and rubber is about 10 to 90%, preferably about 60 to 90%, more preferably 75 to 90%. It has been found that when the transparency is less than 10%, the black coloring is reduced and the gloss is reduced. On the other hand, when transparency exceeds 90%, it can be difficult to use the polypropylene or mixture of polypropylene and rubber as a raw material. The polypropylene or mixture of polypropylene and rubber of the present invention are particularly beneficial because they have sufficient transparency as the crystalline spherulite size is sufficiently small, and thus the black coloring is good even when only a small amount of black coloring agent is added. That is, the black coloring is provided not only on the surface of the molded product but also in the interior of the molded product, thus creating a more luxurious finish.

In an exemplary embodiment, the polypropylene comprises at least one material selected from the group consisting of a polypropylene homopolymer; a random copolymer prepared by copolymerizing 80 to 90 mol % of propylene monomer with 20 to 10 mol % of ethylene, 1-butene, 1-hexene, 1-octene, or 4-methyl-1-pentene comonomer; and a block copolymer prepared by blending 90 to 99 wt % of a homopolymer with 10 to 1 wt % of ethylene-propylene rubber.

Preferred rubbers that are suitable for use in the mixtures of polypropylene and can be selected from, but are not limited to amorphous ethylene-a-olefin copolymers. In certain embodiments, the a-olefin may be propylene, 1-butene, 1-pentene, 1-hexene, 1-octene, or 4-methyl-1-pentene. Polypropylene compositions which include a rubber component are provided with increased impact strength. Further, the contraction rate of polypropylene compositions which include rubber can be easily controlled. In exemplary embodiments, the rubber component is added in an amount of about 5 to 30 wt % with respect to the total weight of the mixture of polypropylene and rubber. It has been found that when the amount of rubber is less than 5 wt %, the effect of increasing the impact strength is reduced. On the other hand, when the amount of rubber exceeds 30 wt %, the stiffness is reduced.

The amount of polypropylene or the mixture of polypropylene and rubber is provided in a large amount of the polypropylene resin composition (i.e., more than about 50 wt % relative to the total weight of the polypropylene resin composition). Preferably, it is provided in an amount of at least about 80 wt %, more preferably, at least about 85 wt % with respect to the total weight of the polypropylene resin composition. In particularly preferred embodiments, the polypropylene or the mixture of polypropylene and rubber is provided in an amount of about 90 to 99.8 wt % with respect to the total weight of the polypropylene resin composition.

In certain preferred embodiments, a crystallization nucleating agent is added to the polypropylene or the mixture of polypropylene and rubber. Such crystallization nucleation agents promote the formation of crystals and increase the amount of crystal nuclei during cooling process, thereby reducing the crystal size of the base resin. As such, by adding crystallization nucleation agents to the polypropylene or polypropylene/rubber mixtures, the transparency of the material is produces with a deep black coloring and a high gloss finish. Further, the degree of crystallization of the base resin is increased, which provides an increase in stiffness, an improvement in heat resistance, an improvement in productivity due to a reduction in cycle time, and prevents distortion. In certain embodiments, the crystallization nucleating agent may comprise at least one selected from the group consisting of phosphoric acid metal salts, carboxylic acid metal salts (such as benzoic acid metal salt, tert-butyl benzoic acid aluminum, etc.), and dibenzylidene sorbitols. In preferred embodiments, the crystallization nucleating agent is added in an amount of about 100 to 5,000 ppm with respect to the total weight of the polypropylene resin composition. It has been found that when the amount of crystallization nucleating agent is less than 100 ppm, the effect of the crystallization nucleating agent is insignificant. On the other hand, when the amount of crystallization nucleating agent exceeds 5,000 ppm, the effect of the crystallization nucleating agent is saturated, and thus any further effect of increasing the amount of crystallization nucleating agent is insignificant and the material cost is increased.

The black coloring agent according to the present invention may comprise at least one selected from the group consisting of carbon black and carbon nanotubes. The black coloring agent may be used in an amount of about 100 to 5,000 ppm. It has been found that when the amount of black coloring is less than 100 ppm, the resulting black coloring is insignificant. On the other hand, when the amount of black coloring exceeds 5,000 ppm, the coloring effect is saturated, and thus the effect of further increasing the amount of black coloring agent becomes negligible and increases the material cost is increased.

The metal oxide nanoparticles according to the present invention absorb ultraviolet rays to thereby improve the weather resistance, and increase the surface stiffness to thereby improve the scratch resistance. Further, the metal oxide nanoparticles serve to form fine projections on the surface, thereby providing water repellent and self-cleaning properties. In preferred embodiments, the metal oxide nanoparticles may comprise at least one selected from the group consisting of ZnO; TiO₂; ZnO doped with Al, In, and Ga; and TiO₂ doped with Al, In, and Ga. It is preferred that the metal oxide nanoparticles have an average diameter of about 5 to 200 nm. It has been found that when the average diameter is less than 5 nm, it is difficult to disperse the nanoparticles in the resin. On the other hand, when the average diameter exceeds 200 nm, the degree of black coloring and the degree of gloss are reduced.

It is preferred that the metal oxide nanoparticles be surface-modified with a silane coupling agent to increase the compatibility with polypropylene and improve the dispersibility. In certain embodiments, silane coupling agent comprises at least one selected from the group consisting of ethyltriethoxysilane, n-propyltrimethoxysilane, n-butyltrimethoxysilane, n-hexyltrimethoxysilane, n-octyltriethoxysilane, n-dodecyltriethoxysilane, hexadecyltrimethoxysilane, n-octadecyltriethoxysilane, n-octadecyltrimethoxysilane, phenyltriethoxysilane, 3-acryloxypropyltrimethoxysilane, allyltriethoxysilane, allyltrimethoxysilane, 3-glycidoxypropyltrimethoxysilane, vinyltriethoxysilane, vinyltrimethoxysilane, N-(2-aminoethyl)-3-aminopropyl trimethoxysilane, 3-aminopropyltriethoxysilane, and 3-aminopropytrimethoxysilane. Preferably, the silane coupling agent is contained in an amount of about 0.1 to 20 wt % with respect to the total weight of the metal oxide nanoparticles surface-modified with the silane coupling agent. It has been found that when the amount of silane coupling agent is less than 0.1 wt %, the effect of dispersing nanopowders is insignificant. On the other hand, if the amount of silane coupling agent exceeds 20 wt %, the silane coupling agent acts as a foreign substance in the polypropylene resin composition, which is economically disadvantageous and further reduces the properties such as impact strength.

In preferred embodiments, the metal oxide nanoparticles are added in an amount of up to about 10 wt %, preferably about 0.2 to 10 wt % with respect to the total weight of the polypropylene resin composition. It has been found that when the amount is less than 0.2 wt %, the improvement of properties such as stiffness, scratch resistance, etc., is insignificant. On the other hand, when the amount of metal oxide nanoparticles exceeds 10 wt %, the degree of black coloring is reduced, the impact strength is considerably reduced, while considerably increasing the material cost.

The composition of the present invention may further comprise various additives and reinforcing materials such as heat resistant stabilizers, weather resistant stabilizers, antistatic agents, lubricants, slip agents, and flame retardants, etc., in such a range that does not impair the objects of the present invention.

While polypropylene has excellent transparency and, thus, has primarily been used in fabrication of packages and containers, it has not been applied in the field of vehicle components because it is known to have low impact resistance and is also known to change in dimensions with variations in temperature. However, the present polypropylene resin compositions are provided with a black high gloss finish and, thus, are suitable substitutes for expensive engineering plastics, which have been used for vehicle interior and exterior components.

Next, the present invention will be described in detail with reference to examples. However, the scope of the present invention is not limited to the following examples.

### EXAMPLES

### Examples 1 to 4 & Comparative Example 1

To prepare polypropylene resin composition with black high gloss finish, the components shown in the following Table 1 were mixed and extruded into pellets using a co-rotating twin screw extruder. The resulting pellets were injection molded into ASTM standard test specimens. Before injection molding, the pellets were dried in an oven at 90° C. for 3 hours to prevent the deterioration of properties due to moisture absorption in the compositions of the Examples and Comparative Example. Molded products were prepared from the pellets using an injection molding machine manufactured by Engel Machinery Korea Ltd. (clamping force: 150 tons). During injection molding, the temperature was 180, 190, 200, and 200° C. in the order from a feeding hopper to a nozzle and the pressure was 30 to 50 bar. The molded products were then tested and their properties recorded.

The content of each component in Table 1 is shown in wt %, and each of the nucleating agent and black coloring agent is shown as a ratio to the total amount of polypropylene resin composition. The transparency was measured from 2 mm thickness specimens according to ASTM D 1003/92 using a spectrophotometer.

TABLE 1

| | | | | | | | | | | Comparative | |
|---|---|---|---|---|---|---|---|---|---|---|---|
| Components | Specification | Example 1 | | Example 2 | | Example 3 | | Example 4 | | Example 1 | |
| Transparent | Polypro 4018 | 99.8 | wt % | 99 | wt % | 89.8 | wt % | — | | — | |
| polypropylene | | | | | | | | | | | |
| Opaque | Polypro CB5108 | — | | — | | — | | 99.8 | wt % | 100 | wt % |
| polypropylene | | | | | | | | | | | |
| Rubber | Adflex X100G | — | | — | | 10 | wt % | — | | — | |
| Metal oxide | ZnO | 0.2 | wt % | 1 | wt % | 0.2 | wt % | 0.2 | wt % | — | |
| nanoparticles | | | | | | | | | | | |
| Nucleating agent | ADK STAB NA-11 | — | | — | | — | | 3,000 | ppm | — | |
| Black coloring | NC7000 | 1,500 | ppm | 1,500 | ppm | 1,500 | ppm | 1,500 | ppm | 1,500 | ppm |

| | |
|---|---|
| agent | (carbon nanotubes) |

* Polypro 4018: Transparency 80; Flow index 19 g/10 min (230° C., 2.16 Kg), manufactured by Korea Petrochemical Ind. Co., Ltd.
* Polypro CB5108: Transparency 0; Flow index 30 g/10 min (230° C., 2.16 Kg), manufactured by Korea Petrochemical Ind. Co., Ltd.
* Adflex X100G: Transparency 82; Flow index 8 g/10 min (230° C., 2.16 Kg), manufactured by Basell
* ZnO: Average diameter of 50 nm; Surface-modified with 5 wt % ethyltriethoxysilane
* ADK STAB NA-11: Phosphoric acid metal salt manufactured by Adeka Corporation
* NC7000: Average diameter of 9.5 nm; Average length 1.5 μm, manufactured by Nanocyl

### Test Example

Tests were performed on the specimens prepared in accordance with Examples 1 to 4 and Comparative Example 1, and the following properties were evaluated

[Measurement Methods]
Degree of black: L values were measured using a colorimeter (the lower the value, the higher the degree of black);
Degree of gloss: Measured using a glossmeter at 60° C.;
Flexural modulus: Measured at room temperature according to ASTM D 790 (Test specimens: 127×12.7×6.4 mm; Crosshead Speed 10 mm/min);
IZOD impact strength: Measured at room temperature according to ASTM D 256 (Test specimens: 63.5×12.7×6.4 mm; Notched specimens were used);
Scratch resistance: Measured as follows; and

| Grade | Appearance |
|---|---|
| 5 | No surface damage |
| 4 | No apparent surface damage |
| 3 | Minute surface damage |
| 2 | Whitened by apparent surface damage |
| 1 | Significant surface damage |
| Test method | Using a diamond scratch tip and a 500 g weight at a |
| | scratch speed of 100 mm/sec; Tip angle 60; Radius 0.5 |

Weather resistance: after UV irradiation (1,000 kJ/m²) according to SAE J1960, the color difference (ΔE) before and after the test was measured using a colorimeter (the lower the color difference ΔE, the better the weather resistance).

TABLE 2

| | | | | | Comparative |
|---|---|---|---|---|---|
| Properties | Example 1 | Example 2 | Example 3 | Example 4 | Example 1 |
| Degree | 2.2 | 4.0 | 2.6 | 4.8 | 8.1 |
| of black | | | | | |
| (L value) | | | | | |
| Degree of | 85.9 | 85.4 | 84.3 | 70.8 | 39.2 |
| gloss at | | | | | |
| 60° C. | | | | | |
| Flexural | 20,000 | 20,800 | 16,500 | 18,800 | 17,050 |
| modulus | | | | | |
| (Kgf/cm²) | | | | | |
| IZOD | 4.0 | 3.8 | 15.6 | 6.7 | 10.0 |
| impact | | | | | |
| strength | | | | | |
| at 23° C. | | | | | |
| (Kgf · | | | | | |
| cm/cm) | | | | | |
| Scratch | 3.0 | 3.5 | 2.5 | 3.0 | 2.5 |
| resistance | | | | | |
| (Grade) | | | | | |
| Weather | 5.4 | 2.0 | 6.5 | 3.6 | 4.8 |
| resistance | | | | | |
| (ΔE) | | | | | |

It can be seen from Table 2 that the degree of black and the degree of gloss of the polypropylene resin compositions prepared using the transparent polypropylene of the invention as a base resin in Examples 1 to 4 are considerably higher than those of the polypropylene resin composition prepared using opaque polypropylene in Comparative Example 1. As further demonstrated, the scratch resistance and the weather resistance of the polypropylene resin compositions prepared by adding ZnO nanoparticles in Examples 1 and 2 was improved. As further demonstrated, the impact strength of the polypropylene resin composition prepared by adding transparent rubber, as in Example 3, was improved while maintaining the degree of black and the degree of gloss. In addition, it was demonstrated that the degree of black, the degree of gloss, the flexural modulus, and the scratch resistance of the polypropylene resin compositions prepared by adding a nucleating agent in Example 4 and Comparative Example 1 were improved.

As described above, the polypropylene resin composition with a black high gloss finish according to the present invention prepared by an injection process can be used as a substitute to replace the existing expensive engineering plastics such as PC, PC/ABS, PC/PBT, PMMA, etc., and thus can contribute to a reduction of manufacturing costs and weight and rendering environmentally friendly characteristics.

Moreover, the polypropylene resin composition according to the present invention can be prepared without requiring the use of a special mold or control system for performing a rapid heating and cooling cycle due to its good fluidity. Furthermore, the use of lightweight materials reduces the weight of the products, and the water repellent and self-cleaning properties of the polypropylene resin composition of the present invention can increase the quality of the products.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A polypropylene resin composition comprising:
90 to 99.8 wt % of polypropylene or a mixture of polypropylene and rubber having a transparency of 10 to 90%;
0.2 to 10 wt % of metal oxide nanoparticles; and
100 to 5,000 ppm of black coloring agent.

2. The polypropylene resin composition of claim 1, wherein the polypropylene comprises at least one selected from the group consisting of a polypropylene homopolymer; a random copolymer prepared by copolymerizing 80 to 90 mol % of propylene monomer with 20 to 10 mol % of ethylene, 1-butene, 1-hexene, 1-octene, or 4-methyl-1-pentene comonomer; and a block copolymer prepared by blending 90 to 99 wt % of a homopolymer with 10 to 1 wt % of ethylene-propylene rubber.

3. The polypropylene resin composition of claim 1, wherein the rubber is an amorphous ethylene-a-olefin copolymer and the a-olefin is propylene, 1-butene, 1-pentene, 1-hexene, 1-octene, or 4-methyl-1-pentene.

4. The polypropylene resin composition of claim 1, wherein the polypropylene or the mixture of polypropylene and rubber further comprises a crystallization nucleating agent.

5. The polypropylene resin composition of claim 4, wherein the crystallization nucleating agent comprises at least one selected from the group consisting of phosphoric acid metal salts, carboxylic acid metal salts, and dibenzylidene sorbitols.

6. The polypropylene resin composition of claim 1, wherein the metal oxide nanoparticles comprise at least one selected from the group consisting of ZnO; TiO₂; ZnO doped with Al, In; and Ga, and TiO₂ doped with Al, In, and Ga.

7. The polypropylene resin composition of claim 1, wherein the metal oxide nanoparticles have an average diameter of 5 to 200 nm.

8. The polypropylene resin composition of claim 1, wherein the metal oxide nanoparticles are surface-modified with a silane coupling agent.

9. The polypropylene resin composition of claim 8, wherein the silane coupling agent comprises at least one selected from the group consisting of ethyltriethoxysilane, n-propyltrimethoxysilane, n-butyltrimethoxysilane, n-hexyltrimethoxysilane, n-octyltriethoxysilane, n-dodecyltriethoxysilane, hexadecyltrimethoxysilane, n-octadecyltriethoxysilane, n-octadecyltrimethoxysilane, phenyltriethoxysilane, 3-acryloxypropyltrimethoxysilane, allyltriethoxysilane, allyltrimethoxysilane, 3-glycidoxypropyltrimethoxysilane, vinyltriethoxysilane, vinyltrimethoxysilane, N-(2-aminoethyl)-3-aminopropyl trimethoxysilane, 3-aminopropyltriethoxysilane, and 3-aminopropytrimethoxysilane.

10. The polypropylene resin composition of claim 1, wherein the black coloring agent comprises at least one selected from the group consisting of carbon black and carbon nanotubes.

11. The polypropylene resin composition of claim 1, wherein the polypropylene resin composition is used as a material for vehicle interior and exterior components.

12. A polypropylene resin composition comprising:
a mixture of polypropylene and rubber having a transparency of 10 to 90%, the rubber comprising 5 to 30 wt % with respect to the weight of the mixture;
metal oxide nanoparticles; and
a black coloring agent.

13. The polypropylene resin composition of claim 16, wherein the polypropylene comprises at least one selected from the group consisting of a polypropylene homopolymer; a random copolymer prepared by copolymerizing 80 to 90 mol % of propylene monomer with 20 to 10 mol % of ethylene, 1-butene, 1-hexene, 1-octene, or 4-methyl-1-pentene comonomer; and a block copolymer prepared by blending 90 to 99 wt % of a homopolymer with 10 to 1 wt % of ethylene-propylene rubber.

14. The polypropylene resin composition of claim 16, wherein the rubber is an amorphous ethylene-a-olefin copolymer and the a-olefin is propylene, 1-butene, 1-pentene, 1-hexene, 1-octene, or 4-methyl-1-pentene.

15. A polypropylene resin composition comprising:
at least 80 wt % of polypropylene or a mixture of polypropylene and rubber;
metal oxide nanoparticles; and
a black coloring agent.

16. The polypropylene resin composition of claim 19, containing at least 85 wt % of polypropylene or a mixture of polypropylene and rubber.

17. The polypropylene resin composition of claim 19, wherein the polypropylene comprises at least one selected from the group consisting of a polypropylene homopolymer; a random copolymer prepared by copolymerizing 80 to 90 mol % of propylene monomer with 20 to 10 mol % of ethylene, 1-butene, 1-hexene, 1-octene, or 4-methyl-1-pentene comonomer; and a block copolymer prepared by blending 90 to 99 wt % of a homopolymer with 10 to 1 wt % of ethylene-propylene rubber.

18. The polypropylene resin composition of claim 19, wherein the polypropylene or the mixture of polypropylene and rubber further comprises a crystallization nucleating agent.
